(19) United States
(12) Patent Application Publication
(10) Pub. No.: US 2015/0017535 A1
(43) Pub. Date: Jan. 15, 2015

(54) CATHODE ACTIVE MATERIAL, METHOD OF PREPARING THE CATHODE ACTIVE MATERIAL, AND CATHODE AND LITHIUM SECONDARY BATTERY INCLUDING THE CATHODE ACTIVE MATERIAL

(71) Applicant: SAMSUNG SDI CO., LTD., Yongin-si (KR)

(72) Inventors: Ming-Zi Hong, Yongin-si (KR); Do-Hyung Park, Yongin-si (KR); Seon-Young Kwon, Yongin-si (KR); Joong-Ho Moon, Yongin-si (KR); Ji-Hyun Kim, Yongin-si (KR); Han-Eol Park, Yongin-si (KR); Min-Han Kim, Yongin-si (KR); Myong-A Woo, Yongin-si (KR); Ki-Hyun Kim, Yongin-si (KR); Sun-Ho Kang, Yongin-si (KR)

(73) Assignee: SAMSUNG SDI CO., LTD., Yongin-si (KR)

(21) Appl. No.: 14/084,559

(22) Filed: Nov. 19, 2013

(30) Foreign Application Priority Data
Jul. 12, 2013 (KR) 10-2013-0082300

(51) Int. Cl. H01M 4/36; H01M 4/525; H01M 4/04; H01M 4/485

(52) U.S. Cl. CPC H01M 4/366; H01M 4/485; H01M 4/525; H01M 4/0402
USPC 429/220; 429/231.1; 429/231.3; 429/231.2; 429/221; 429/224; 427/126.3

(57) ABSTRACT

A cathode active material, a preparation method thereof, and a cathode for a lithium secondary battery and a lithium secondary battery including the cathode active material, wherein the cathode active material includes a core active material represented by Formula 1 below; and a coating layer formed on a surface of the core active material, the coating layer including lithium gallium oxide:

Liₐ(A_{1-x-y}BₓC_{y})O₂ Formula 1

In Formula 1, a, x, y, A, B, and C are defined in the detailed description.

### CROSS-REFERENCE TO RELATED APPLICATION

This application claims priority to and the benefit of Korean Patent Application No. 10-2013-0082300, filed on Jul. 12, 2013, in the Korean Intellectual Property Office, the disclosure of which is incorporated herein in its entirety by reference.

### BACKGROUND

1. Field

One or more embodiments of the present invention relate to a cathode active material, a method of preparing the cathode active material, and a cathode and a lithium secondary battery including the cathode active material.

2. Description of the Related Art

Currently, application of a lithium secondary battery in cell phones, camcorders, and laptop computers is a trend that is rapidly increasing. A factor that influences capacity of the lithium secondary battery is a cathode active material. Characteristics of the lithium secondary battery (such as, whether the lithium secondary battery is available for a long-term use in high rates by its electrochemical characteristics or whether an initial capacity of the lithium secondary battery is maintained during a charge-discharge cycle) are determined.

The cathode active material of the lithium secondary battery may be a lithium cobalt oxide or a lithium nickel composite oxide.

However, conventional cathode materials have capacity, stability, and lifetime that do not reach a satisfactory level, leaving a lot of room for improvement.

### SUMMARY

One or more aspects of embodiments of the present invention are directed towards a cathode active material, a lithium secondary battery cathode including the cathode active material, and a lithium secondary battery including the cathode.

Additional aspects will be set forth in part in the description which follows and, in part, will be apparent from the description, or may be learned by practice of the presented embodiments.

According to one or more embodiments of the present invention, a cathode active material includes a core active material represented by Formula 1 below; and a coating layer formed on a surface of the core active material and including a lithium gallium oxide:

Liₐ(A_{1-x-y}BₓC_{y})O₂ Formula 1

wherein, in Formula 1, 0.9≦a≦1.0, 0<x≦1, and 0≦y≦1,

A is an element selected from the group consisting of Ni, Co, and Mn,

B is an element selected from the group consisting of Ni, Co, Mn, B, Mg, Ca, Sr, Ba, Ti, V, Cr, Fe, Cu, and Al,

C is an element selected from the group consisting of Ni, Co, Mn, B, Mg, Ca, Sr, Ba, Ti, V, Cr, Fe, Cu, and Al, and A, B, and C are different from each other.

According to one or more embodiments of the present invention, a method of preparing a cathode active material includes obtaining a first mixture by combining a gallium precursor, a lithium precursor and a solvent; obtaining a second mixture by combining the first mixture with a core active material represented by Formula 1 below; performing a heat treatment on the second mixture; and obtaining the cathode active material comprising the core active material represented by Formula 1 below and a coating layer formed on a surface of the core active material, the coating layer including a lithium gallium oxide:

Liₐ(A_{1-x-y}BₓC_{y})O₂ Formula 1

wherein, in Formula 1 above, 0.9≦a≦1.0, 0<x≦1, and 0≦y≦1,

A is an element selected from the group consisting of Ni, Co, and Mn,

B is an element selected from the group consisting of Ni, Co, Mn, B, Mg, Ca, Sr, Ba, Ti, V, Cr, Fe, Cu, and Al,

C is an element selected from the group consisting of Ni, Co, Mn, B, Mg, Ca, Sr, Ba, Ti, V, Cr, Fe, Cu, and Al, and A, B, and C are different from each other.

According to one or more embodiments of the present invention, the second mixture is sol state.

According to one or more embodiments of the present invention, a lithium secondary battery cathode includes a cathode active material.

According to one or more embodiments of the present invention, a lithium secondary battery includes the above-described cathode.

### BRIEF DESCRIPTION OF THE DRAWINGS

These and/or other aspects will become apparent and more readily appreciated from the following description of the embodiments, taken in conjunction with the accompanying drawings in which:

FIG. 1 is a schematic view of a lithium secondary battery prepared according to an embodiment of the present invention;

FIG. 2 is a graph showing X-ray diffractometer (XRD) analysis of cathode active materials according to the Examples 2 and 3, LiNi_{0.56}Co_{0.22}Mn_{0.22}O₂ (NCM B) and LiNi_{0.33}Co_{0.33}Mn_{0.33}O₂ (NCM A);

FIG. 3 is a graph showing thermal analysis result of cathode active materials of Examples 1 to 4, LiNi_{0.56}Co_{0.22}Mn_{0.22}O₂ (NCM B) and LiNi_{0.33}Co_{0.33}Mn_{0.33}O₂ (NCM A) by using a differential scanning calorimetry (DSC);

FIG. 4 is a graph showing characteristics of charge and discharge of coin cells prepared according to each of Manufacture Examples 1 and 3 and Comparative Manufacture Example 1; and

FIG. 5 is a graph showing high-temperature charge and discharge characteristics of coin cells prepared according to each of Manufacture Example 1 and Comparative Manufacture Example 1.

### DETAILED DESCRIPTION

Reference will now be made in detail to embodiments, examples of which are illustrated in the accompanying drawings, wherein like reference numerals refer to the like elements throughout. In this regard, the present embodiments may have different forms and should not be construed as being limited to the descriptions set forth herein. Accordingly, the embodiments are merely described below, by referring to the figures, to explain aspects of the present description. Expressions such as “at least one of,” when preceding a list of elements, modify the entire list of elements and do not modify the individual elements of the list. Further, the use of “may” when describing embodiments of the present invention refers to “one or more embodiments of the present invention.”

According to an embodiment of the present invention, there is provided a cathode active material including a core active material represented by Formula 1 below; and a coating layer formed on a surface of the core active material, the coating layer including lithium gallium oxide:

Liₐ(A_{1-x-y}BₓC_{y})O₂ Formula 1

In Formula 1, 0.9≦a≦1.0, 0<x≦1, and 0≦y≦1,

A is an element selected from the group consisting of Ni, Co, and Mn,

B is an element selected from the group consisting of Ni, Co, Mn, B, Mg, Ca, Sr, Ba, Ti, V, Cr, Fe, Cu, and Al,

C is an element selected from the group consisting of Ni, Co, Mn, B, Mg, Ca, Sr, Ba, Ti, V, Cr, Fe, Cu, and Al, and

A, B, and C are different from each other.

The core active material represented by Formula 1 above may be represented by Formula 2 below:

Liₐ(Ni_{1-x-y}CoₓMn_{y})O₂ Formula 2

In Formula 2, 0.9≦a≦1.0, 0<x≦1, and 0≦y≦1.

An amount of the lithium gallium oxide may be in a range of about 0.001 to about 15 parts by weight, and in some embodiments, may be in a range of about 0.1 to about 5 parts by weight, based on 100 parts by weight of the core active material of Formula 1 above. When the amount of the lithium gallium oxide is within the above ranges, the cathode active material may have improved capacity, lifetime, and thermal stability, compared to a cathode active material in which a coating layer having lithium gallium oxide is not formed.

The lithium gallium oxide may be chemically stable.

A thickness of the coating layer having the lithium gallium oxide may be about 800 nm or less, and in some embodiments, may be in a range of about 3 to about 800 nm.

In some embodiments, the cathode active material may be LiNi_{0.56}Co_{0.22}Mn_{0.22}O₂, LiNi_{0.33}Co_{0.33}Mn_{0.33}O₂, LiNi_{0.5}Co_{0.2}Mn_{0.3}O₂, LiNi_{0.4}Co_{0.3}Mn_{0.3}O₂, or LiNi_{0.6}Co_{0.2}Mn_{0.2}O₂.

The cathode active material may be formed of spherical particles. The term ‘spherical’ used herein may refer to a round shape or an oval shape, but is not limited thereto.

Hereinafter, a method of preparing the cathode active material will be described in more detail.

In some embodiments, a gallium precursor and a first solvent are mixed together to prepare a first mixture.

The gallium precursor may be at least one selected from the group consisting of gallium nitrate, gallium alkoxide, gallium hydroxide, gallium sulfate, and gallium chloride.

The first solvent may be water, ethanol, propanol, or butanol. An amount of the first solvent may be in a range of about 100 to about 2,000 parts by weight based on 100 parts by weight of the gallium precursor.

In one embodiment, the first mixture and the compound of Formula 1 above are mixed together to prepare a second mixture.

Next, the second mixture is heat treated to obtain a cathode active material including the core active material represented by Formula 1 above and the coating layer formed on a surface of the core active material and including the lithium gallium oxide.

After the second mixture is prepared, drying the second mixture at a temperature in a range of about 80 to about 150° C. may be further included as necessary.

In some embodiments, the heat treatment is performed at a temperature in a range of about 400 to about 1,000° C. When the temperature is within the above ranges, the cathode active material may be effectively formed. Heat treatment time may vary according to heat treatment temperatures, but the heat treatment may be performed for about 1 to about 7 hours.

Hereinafter, a method of preparing a lithium secondary battery using the cathode active material as a lithium battery cathode active material will be now described in detail. According to an embodiment of the present invention, a method of preparing a lithium secondary battery including a cathode, an anode, a non-aqueous electrolyte containing a lithium salt, and a separator is provided.

The cathode and the anode may be each prepared by coating and drying a cathode active material-forming composition and an anode active material-forming composition on a current collector.

In some embodiments, the cathode active material-forming composition is prepared by mixing a cathode active material, a conducting agent, a binder, and a solvent together. The cathode active material may include the core active material of Formula 1 and the coating layer formed on a surface of the core active material and including the lithium gallium oxide.

In some embodiments, besides the above-described cathode active material, any cathode active material suitable for use in a lithium secondary battery may be mixed and used.

The binder may be a material that assists in binding of the cathode active material to a conducting agent, and/or in binding of the cathode active material and/or the conduction agent to a current collector. The binder may be added in a range of about 1 to about 50 parts by weight based on 100 parts by weight of the total weight of the cathode active material. Non-limiting examples of the binder are polyvinylidene difluoride, polyvinyl alcohol, carboxymethylcellulose (CMC), starch, hydroxypropylcellulose, regenerated cellulose, polyvinylpyrrolidone, tetrafluoroethylene, polyethylene, polypropylene, ethylene-propylene-dieneterpolymer (EPDM), sulfonated EPDM, styrene butyrene rubber, fluororubber, and various copolymers. An amount of the binder may be in a range of about 2 to about 5 parts by weight based on 100 parts by weight of the total weight of the cathode active material. When the amount of the binder is within the above ranges, the cathode active material-forming composition may have satisfactory binding strength to the current collector.

The conducting agent may be any suitable conducting agent, as long as it has conductivity without inducing chemical changes in the battery. Non-limiting examples of the conducting agent are graphite such as natural graphite or artificial graphite; carbonaceous materials such as acetyleneblack, Ketjen black, channel black, furnace black, lamp black, or thermal black; conductive fibers such as carbon fibers or metallic fibers, metallic powder such as fluoro carbon powder, aluminum powder, or nickel powder; conductive whisker such as zinc oxide or potassium titanate; conductive metallic oxides such as titanium oxide; and conductive materials such as polyphenylene derivatives.

An amount of the conducting agent may be in a range of about 2 to about 5 parts by weight based on 100 parts by weight of the total weight of the cathode active material. When the amount of the conducting agent is within the above ranges, the resulting electrode may have relatively high conductivity.

A non-limiting example of the solvent is N-methyl pyrrolidone.

An amount of the solvent may be in a range of about 1 to about 10 parts by weight based on 100 parts by weight of the total weight of the cathode active material. When the amount of the solvent is within the above ranges, the cathode active material may be effectively formed.

A thickness of the cathode current collector may be in a range of about 3 to about 500 μm. The cathode current collector may be any suitable cathode current collector, as long as it has high conductivity without inducing chemical changes in the battery. Non-limiting examples of the cathode current collector are stainless steel, aluminum, nickel, titanium, heat treated carbon, and materials in which carbon, nickel, and titanium are heat treated on a surface of the stainless steel. The cathode current collector may have micro unevenness on its surface to increase adhesion of the cathode current collector to the cathode active materials. The micro unevenness may be formed in various shapes, such as film, sheet, foil, net, porous body, foaming body, or non-woven fabric body.

The anode active material-forming composition may be separately prepared by mixing an anode active material, a conducting agent, and a solvent.

The anode active material may intercalate and deintercalate lithium ions. Non-limiting examples of the anode active material are carbonaceous materials such as graphite and carbon, lithium metals, alloys thereof, and silicon oxide-based materials. In some embodiments, the silicon oxide may be used herein.

The binder may also be added in an amount that ranges from about 1 to about 50 parts by weight based on 100 parts by weight of the total weight of the anode active material. Non-limiting examples of the binder are the same as those described above in connection with the cathode active material-forming composition.

An amount of the conducting agent may be in a range of about 1 to about 5 parts by weight based on 100 parts by weight of the total weight of the anode active material. When the amount of the conducting agent is within the above ranges, the resulting electrode may have relatively high conductivity.

An amount of the solvent may be in a range of about 1 to about 10 parts by weight based on 100 parts by weight of the total weight of the anode active material. When the amount of the solvent is within the above ranges, the anode active material may be effectively formed.

Non-limiting examples of the conducting agent and the solvent are the same as described above in connection with a manufacture of the cathode.

An anode current collector may be formed with a thickness in a range of about 3 to about 500 μm. The anode current collector may be any suitable anode current collector as long as it has high conductivity without inducing chemical changes in the battery. Non-limiting examples of the anode current collector are copper, stainless steel, aluminum, nickel, titanium, heat treated carbon, materials in which carbon, nickel, titanium, and silver are treated on a surface of the stainless steel, and aluminum-cadmium alloy. As described above in connection with the cathode current collector, the anode current collector may have micro unevenness on its surface to increase adhesion of the anode current collector to the anode active materials. The micro unevenness may be formed in various shapes, such as film, sheet, foil, net, porous body, foaming body, or non-woven fabric body.

A separator may be positioned between the cathode and the anode.

The separator may have a thickness in a range of about 0.01 to about 10 μm, and in some embodiments, of about 5 to about 300 μm. Non-limiting examples of the separator are olefin polymers such as polypropylene and polyethylene, and sheet and non-woven fabric that are formed of fiberglass. In the embodiments where the electrolyte is a solid electrolyte such as a polymer, the solid electrolyte may also serve as the separator.

The non-aqueous electrolyte containing the lithium salt may be composed of a non-aqueous electrolyte solution and lithium. Non-limiting examples of the non-aqueous electrolyte are an organic solid electrolyte and an inorganic solid electrolyte.

A non-limiting example of the non-aqueous electrolyte solution is aprotic organic solvent, such as N-methyl-2-pyrrolidinone, propylene carbonate, ethylene carbonate, butylene carbonate, dimethyl carbonate, diethyl carbonate, gamma-butyrolactone, 1,2-dimethoxy ethane, 2-methyl tetrahydrofuran, dimethyl sulfoxide, 1,3-dioxolane, N,N-formamide, N,N-dimethyl formamide, dioxolane, acetonitrile, nitromethane, methyl formate, methyl acetate, phosphate triester, trimethoxy methane, dioxolane derivatives, sulfolane, methyl sulfolane, 1,3-dimethyl-2-imidazolidinone, propylene carbonate, tetrahydrofuran derivates, ether, propionic methyl, or propionic ethyl.

Non-limiting examples of the organic solid electrolyte are a polyethylene derivative, a polyethylene oxide derivative, a phosphate ester polymer, polyester sulfide, polyvinyl alcohol, and polyvinylidene difluoride.

Non-limiting examples of the inorganic solid electrolyte are lithium nitrate, lithium halide, and lithium sulfate. In some embodiments, Li₃N, LiI, Li₅NI₂, Li₃N—LiI—LiOH, Li₂SiS₃, Li₄SiO₄, Li₄SiO₄—LiI—LiOH, or Li₃PO₄—Li₂S—SiS₂ is used as the inorganic solid electrolyte.

The lithium salt may include a material that is well dissolved in the non-aqueous electrolyte. Non-limiting examples of the lithium salt are LiCl, LiBr, LiI, LiClO₄, LiBF₄, LiB₁₀Cl₁₀, LiPF₆, LiCF₃SO₃, LiCF₃CO₂, LiAsF₆, LiSbF₆, LiAlCl₄, CH₃SO₃Li, CF₃SO₃Li, (CF₃SO₂)₂NLi, lithium chloroborate, lower aliphatic lithium carboxylic acid, and lithium tetraphenyl borate.

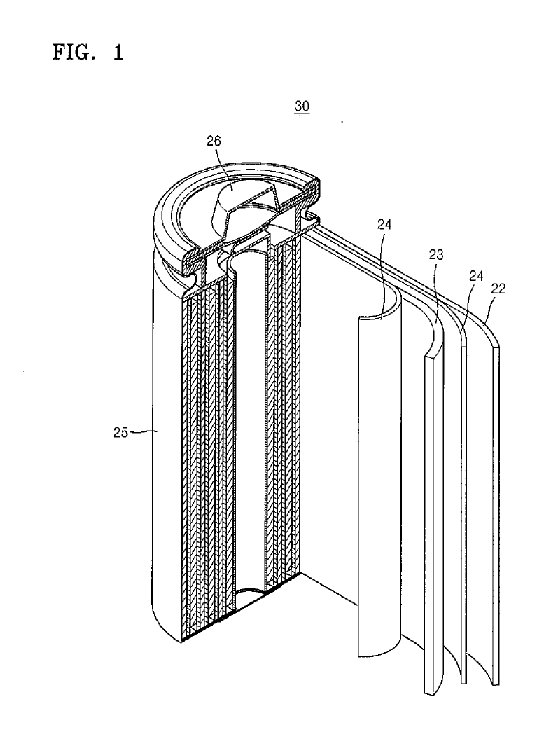

FIG. 1 is a schematic view of a lithium secondary battery 30 prepared according to an embodiment of the present invention.

Referring to FIG. 1, the lithium secondary battery 30 may include a cathode 23, an anode 22, and a separator 24 interposed between the cathode 23 and the anode 22, an electrolyte, impregnated in the cathode 23, the anode 22, and the separator 24, a battery case 25, and a filling member that fills the battery case 25. In the lithium secondary battery 30, the cathode 23, the anode 22, and the separator 24 may be sequentially stacked, and then spirally winded to be put in the battery case 25. The battery case 25 may be sealed with the cap assembly 26, thereby completing a manufacture of the lithium secondary battery 30.

Hereinafter the present invention will be described in detail with reference to the following synthesis examples and other examples. However, these examples are for illustrative purposes only and are not intended to limit the scope of the present invention.

### EXAMPLE 1

### Preparation of Cathode Active Material

0.95 g of gallium nitrate Ga(NO₃)₃.nH₂O (Assay(Ga): 19.0 wt %) was dissolved in 30 ml of distilled water, which was used as a solvent. Then, the mixed solution, which was used as a gallium salt, was stirred to prepare a gallium salt solution.

1.08 g of citric acid was added into 10 ml of distilled water and stirred to prepare a second solution.

The two solutions were mixed together and then stirred to prepare a transparent solution. 0.16 g of citric acid was added thereto, and the mixed solution was sufficiently stirred for 10 to 30 minutes.

50 g of LiNi_{0.56}Co_{0.22}Mn_{0.22}O₂ was added to the solution containing the gallium salt, and then the mixed solution was stirred at 80° C. until the water was completely evaporated. The resultant product was heat treated at a temperature of 700° C. for 7.5 hours to obtain LiNi_{0.56}Co_{0.22}Mn_{0.22}O₂ coated with lithium gallium oxide (LiGaO₂). Here, an amount of LiGaO₂ was about 0.56 parts by weight based on 100 parts by weight of LiNi_{0.56}Co_{0.22}Mn_{0.22}O₂.

### EXAMPLE 2

### Preparation of Cathode Active Material

LiNi_{0.56}Co_{0.22}Mn_{0.22}O₂ coated with LiGaO₂ was prepared in the same manner as in Example 1, except that 30 ml of ethanol was used instead of 30 ml of distilled water during the preparation of the gallium salt solution.

1.08 g of citric acid was added into 10 ml of ethanol and stirred to obtain a second solution.

Here, an amount of LiGaO₂ was about 1.12 parts by weight based on 100 parts by weight of LiNi_{0.56}Co_{0.22}Mn_{0.22}O₂.

### EXAMPLE 3

### Preparation of Cathode Active Material

LiNi_{0.56}Co_{0.22}Mn_{0.22}O₂ coated with LiGaO₂ was prepared in the same manner as in Example 1, except that 9.5 g of nitrate gallium was used during the preparation of the gallium salt solution. Here, an amount of LiGaO₂ was about 5.6 parts by weight based on 100 parts by weight of LiNi_{0.56}Co_{0.22}Mn_{0.22}O₂.

### EXAMPLE 4

### Preparation of Cathode Active Material

LiNi_{0.56}Co_{0.22}Mn_{0.22}O₂ coated with LiGaO₂ was prepared in the same manner as in Example 1, except that 19 g of nitrate gallium was used during the preparation of the gallium salt solution. Here, an amount of LiGaO₂ was about 11.2 parts by weight based on 100 parts by weight of LiNi_{0.56}Co_{0.22}Mn_{0.22}O₂.

### MANUFACTURE EXAMPLE 1

### Preparation of Coin Cell

A coin cell was prepared by using the cathode active material of Example 1.

96 g of the cathode active material of Example 1, 2 g of polyvinylidene fluoride, 47 g of N-methylpyrrolidone as a solvent, and 2 g of carbon black as a conducting agent were mixed together. Then, the mixture was stirred using a mixer to prepare a slurry of a cathode active material layer.

The slurry was applied to an aluminum thin plate by using a doctor blade to form a cathode thin plate. Then, the cathode thin plate was dried at a temperature of 135° C. for 3 hours or more, rolled, and vacuum dried to prepare a cathode.

Lithium metal was used as a counter electrode, and the lithium metal and the cathode were used together to prepare a 2032 sized coin cell. A separator (having a thickness of about 16 μm), which is formed of porous polyethylene (PE) film, was positioned between the cathode and the lithium metal, and an electrolytic solution was injected thereto to prepare the coin cell.

Here, 1.1M LiPF₆ solution was used as the electrolytic solution. The 1.1M LiPF₆ solution was prepared by adding LiPF₆ into the solvent in which ethylene carbonate (EC) and ethylmethyl carbonate (EMC) were mixed in a volume ratio of 3:5.

### MANUFACTURE EXAMPLES 2-4

### Preparation of Coin Cell

A coin cell was prepared in the same manner as in Manufacture Example 1, except that the cathode active materials of Examples 2-4 were used instead of the cathode active material of Example 1.

### COMPARATIVE MANUFACTURE EXAMPLE 1

### Preparation of Coin Cell

A coin cell was prepared in the same manner as in Manufacture Example 1, except that LiNi_{0.56}Co_{0.22}Mn_{0.22}O₂ was used instead of the cathode active material of Example 1.

### COMPARATIVE MANUFACTURE EXAMPLE 2

### Preparation of Coin Cell

A coin cell was prepared in the same manner as in Comparative Manufacture Example 1, except that LiNi_{0.33}Co_{0.33}Mn_{0.33}O₂ was used instead of the cathode active material of Example 1.

### EVALUATION EXAMPLE 1

### X-Ray Diffractometer (XRD) Test

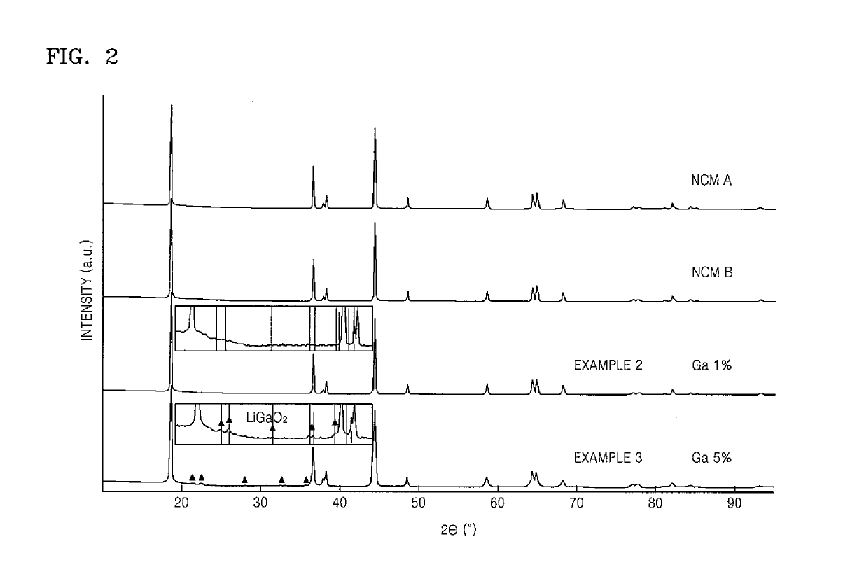

Characteristics of crystal structures of cathode active materials according to the Examples 2 and 3, LiNi_{0.56}Co_{0.22}Mn_{0.22}O₂ (NCM B) and LiNi_{0.33}Co_{0.33}Mn_{0.33}O₂ (NCM A) were evaluated by using an X-ray diffractometer (XRD) (i.e., MAC Science MXP3A-HF), and results are shown in FIG. 2.

Referring to FIG. 2, the cathode active materials of Examples 2 and 3 were found to have XRD patterns formed on LiGaO₂ phase unlike NCM A and NCM B.

### EVALUATION EXAMPLE 2

### Thermal Analysis Test

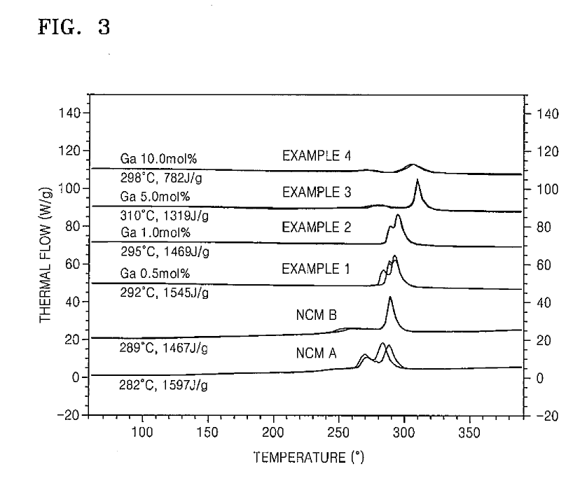

Thermal analysis test was performed on the cathode active materials of Examples 1-4, LiNi_{0.56}Co_{0.22}Mn_{0.22}O₂ (NCM B) and LiNi_{0.33}Co_{0.33}Mn_{0.33}O₂ (NCM A) by using a differential scanning calorimetry (DSC), and results are shown in FIG. 3.

Referring to FIG. 3, the cathode active materials of Examples 1-4 were found to have significant improvement in the thermal stability compared to LiNi_{0.56}Co_{0.22}Mn_{0.22}O₂ and LiNi_{0.33}Co_{0.33}Mn_{0.33}O₂, since the main exothermic peak was significantly shifted toward high temperatures.

### EVALUATION EXAMPLE 3

### Lifetime Test

Lifetime of the coin cells of Manufacture Examples 1 and 3 and Comparative Manufacture Example 1 was evaluated.

Charge and discharge characteristics of the coin cells were evaluated by using a charge and discharger (i.e., TOSCAT-3100 manufactured by TOYO).

A formation step of the coin cells of each of Manufacture Examples 1 and 3 and Comparative Manufacture Example 1 was followed by performing one charge and discharge cycle by flowing a current 0.1 C. Then, characteristics of the initial charge and discharge cycle including one charge and discharge cycle by flowing a current of 0.2 C and another charge and discharge cycle by flowing a current of 0.5 C were determined. The charge and discharge cycle was repeated 50 times by flowing a current of 1 C, and then the cycle characteristics were determined. The charge and discharge cycle was set to cut off at a voltage of 4.3 V in a constant current (CC) mode during the charge cycle, and to cut off at a voltage of 3 V in a CC mode during the discharge cycle.

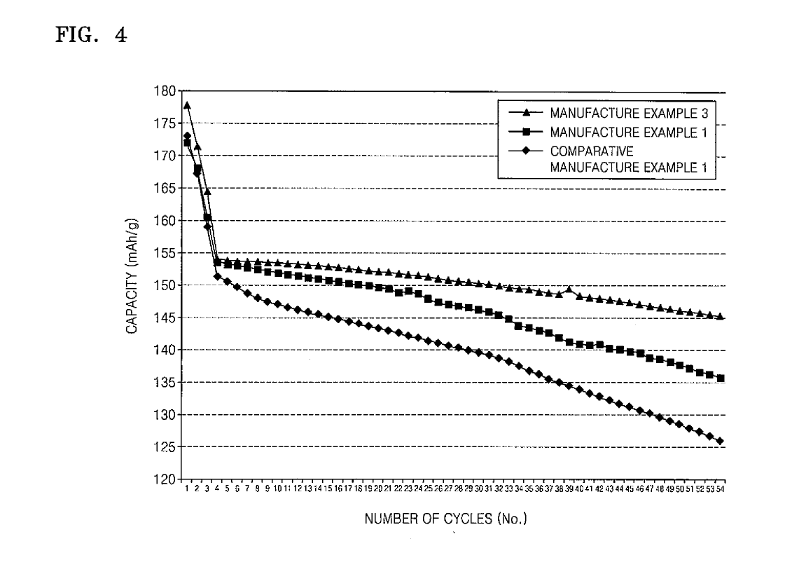

Changes in discharge capacity after the 50 cycles of the charge and discharge are shown in FIG. 4.

Referring to FIG. 4, the coin cells of Manufacture Examples 1 and 3 were found to have improved lifetime compared to the coin cell of Comparative Manufacture Example 1.

### EVALUATION EXAMPLE 4

### High-Temperature Charge and Discharge Test

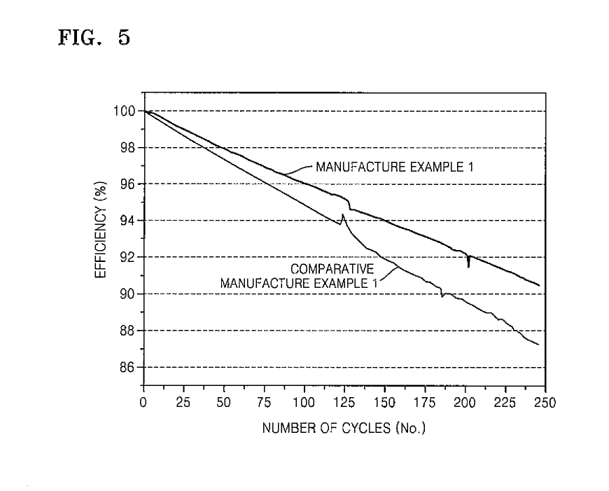

The coin cells of each of Manufacture Example 1 and Comparative Manufacture Example 1 were charged in the first cycle at 0.1 C at a temperature of 45° C. until their voltage reached 4.2 V. After 10 minutes of rest, the coin cells were discharged at 0.1 C at a temperature of 45° C. until their voltage reached 3.0 V. Then, the charge-discharge cycle was repeated 350 times under conditions of charging to 4.2 V at a 1 C and discharging to 3.0 V at 1 C. Characteristics of the charge and discharge are shown in FIG. 5.

Capability retention in the 100^{th} cycle may be represented by Equation 1 below:

Capability retention in the 100^{th} cycle [%]=[discharge capability in the 100^{th} cycle/discharge capability in the 1^{st} cycle]×100 [Equation 1]

Referring to FIG. 5, the coin cell of Manufacture Example 1 is found to have better capability retention compared to the coin cell of Comparative Manufacture Example 1.

### EVALUATION EXAMPLE 5

### High-Temperature Storage Characteristics

The coin cells of each of Manufacture Example 1 and Comparative Manufacture Example 1 were charged in the first cycle at 0.1 C at a temperature of 40° C. until their voltage reached 4.2 V. Then, a constant voltage charge was performed thereon until their current reached 0.01 C. After 10 minutes of rest, the coin cells were discharged at 0.1 C at a temperature of 40° C. until their voltage reached 3.0 V.

The coin cells were stored at a temperature of 60° C. each for 10 days and 20 days. Then, changes in storage capacity recovery and resistance were measured, and results are shown in Table 1 below.

The storage capacity recovery was measured after the coin cells of Manufacture Example 1 and Comparative Manufacture Example 1 were stored at a temperature of 60° C. each for 10 days and 20 days. Here, the charge and discharge was performed thereon in the same manner as when measuring capacity of the coin cells before the storage. That is, the coin cells were charged at a temperature of 40° C. at 0.1 C until their voltage reached 4.2 V, and a current voltage charge was performed thereon until their current reached 0.01 C. After 10 minutes of rest, the coin cells were discharged at a temperature of 40° C. at 0.1 C until their voltage reached 3.0 V. Here, the discharge capacity is divided by the capacity of the coin cells before high-temperature storage, and the resulting number is represented in a percentage.

Impedance changes before and after high-temperature storage were measured by impedance of the coin cells.

TABLE 1

| | Storage capacity recovery | | | |
|---|---|---|---|---|
| | (%) | | Impedance change (%) | |
| | 10 days later | 20 days later | 10 days later | 20 days later |
| Manufacture | 92 | 90 | 121 | 131 |
| Example1 | | | | |
| Comparative | 92 | 87 | 127 | 149 |
| Manufacture | | | | |
| Example 1 | | | | |

Referring to Table 1 above, the coin cell of Manufacture Example 1 was found to have improved capacity for high-temperature storage compared to the coin cell of Comparative Manufacture Example 1, since extents of the decreased capacity retention and increased resistance are reduced.

As described above, according to the one or more of the above embodiments of the present invention, a cathode active material has relatively high thermal stability, and thus a lithium secondary battery having excellent high-temperature storage characteristics, long lifetime, and good capacity may be prepared by using the above-described cathode active material.

It should be understood that the exemplary embodiments described therein should be considered in a descriptive sense only and not for purposes of limitation. Descriptions of features or aspects within each embodiment should typically be considered as available for other similar features or aspects in other embodiments.

While one or more embodiments of the present invention have been described with reference to the figures, it will be understood by those of ordinary skill in the art that various changes in form and details may be made therein without departing from the spirit and scope of the present invention as defined by the following claims, and equivalents thereof.

What is claimed is:

1. A cathode active material comprising:
a core active material represented by Formula 1; and
a coating layer on a surface of the core active material, the coating layer comprising lithium gallium oxide:
Liₐ(A_{1-x-y}BₓC_{y})O₂ [Formula 1]
wherein, in Formula 1, 0.9≦a≦1.0, 0<x≦1, and 0≦y≦1,
A is an element selected from the group consisting of Ni, Co, and Mn,
B is an element selected from the group consisting of Ni, Co, Mn, B, Mg, Ca, Sr, Ba, Ti, V, Cr, Fe, Cu, and Al,
C is an element selected from the group consisting of Ni, Co, Mn, B, Mg, Ca, Sr, Ba, Ti, V, Cr, Fe, Cu, and Al, and
A, B, and C are different from each other.

2. The cathode active material of claim 1, wherein the core active material of Formula 1 is represented by Formula 2:
Liₐ(Ni_{1-x-y}CoₓMn_{y})O₂ [Formula 2]
wherein, in Formula 2, 0.9≦a≦1.0, 0<x≦1, and 0≦y≦1.

3. The cathode active material of claim 1, wherein the core active material represented by Formula 1 is LiNi_{0.56}Co_{0.22}Mn_{0.22}O₂, LiNi_{0.33}Co_{0.33}Mn_{0.33}O₂, LiNi_{0.5}Co_{0.2}Mn_{0.3}O₂, LiNi_{0.4}Co_{0.3}Mn_{0.3}O₂, or LiNi_{0.6}Co_{0.2}Mn_{0.2}O₂.

4. The cathode active material of claim 1, wherein an amount of the lithium gallium oxide is in a range of about 0.001 to about 15 parts by weight based on 100 parts by weight of the core active material represented by Formula 1.

5. The cathode active material of claim 1, wherein a thickness of the coating layer is about 800 nm or less.

6. A method of preparing a cathode active material, the method comprising:
combining a gallium precursor, a lithium precursor, and a solvent to obtain a first mixture;
combining the first mixture and a core active material represented by Formula 1 to obtain a second mixture; and
heat treating the second mixture to obtain the cathode active material comprising the core active material represented by Formula 1 and a coating layer on a surface of the core active material, the coating layer comprising lithium gallium oxide.
Liₐ(A_{1-x-y}BₓC_{y})O₂ [Formula 1]
wherein, in Formula 1, 0.9≦a≦1.0, 0<x≦1, and 0≦y≦1,
A is an element selected from the group consisting of Ni, Co, and Mn,
B is an element selected from the group consisting of Ni, Co, Mn, B, Mg, Ca, Sr, Ba, Ti, V, Cr, Fe, Cu, and Al,
C is an element selected from the group consisting of Ni, Co, Mn, B, Mg, Ca, Sr, Ba, Ti, V, Cr, Fe, Cu, and Al, and
A, B, and C are different from each other.

7. The method of claim 6, wherein the gallium precursor is at least one selected from the group consisting of gallium nitrate, gallium alkoxide, gallium hydroxide, gallium sulfate, and gallium chloride.

8. The method of claim 6, wherein the solvent is water, methanol, ethanol, or a mixture thereof.

9. The method of claim 6, wherein the obtaining of the second mixture is performed by impregnating the core active material represented by Formula 1 in the first mixture.

10. The method of claim 6, wherein the second mixture is sol state.

11. The method of claim 6, wherein the heat treatment is performed at temperature in a range of about 400 to about 1,000° C.

12. A lithium secondary battery cathode comprising a cathode active material comprising a core active material represented by Formula 1 and a coating layer on a surface of the core active material, the coating layer comprising lithium gallium oxide:
Liₐ(A_{1-x-y}BₓC_{y})O₂ [Formula 1]
wherein, in Formula 1, 0.9≦a≦1.0, 0<x≦1, and 0≦y≦1,
A is an element selected from the group consisting of Ni, Co, and Mn,
B is an element selected from the group consisting of Ni, Co, Mn, B, Mg, Ca, Sr, Ba, Ti, V, Cr, Fe, Cu, and Al,
C is an element selected from the group consisting of Ni, Co, Mn, B, Mg, Ca, Sr, Ba, Ti, V, Cr, Fe, Cu, and Al, and
A, B, and C are different from each other.

13. The lithium secondary battery cathode of claim 12, wherein the core active material of Formula 1 is represented by Formula 2 below:
Liₐ(Ni_{1-x-y}CoₓMn_{y})O₂ [Formula 2]
wherein, in Formula 2, 0.9≦a≦1.0, 0<x≦1, and 0≦y≦1.

14. The lithium secondary battery cathode of claim 12, wherein the core active material represented by Formula 1 is LiNi_{0.56}Co_{0.22}Mn_{0.22}O₂, LiNi_{0.33}Co_{0.33}Mn_{0.33}O₂, LiNi_{0.5}Co_{0.2}Mn_{0.3}O₂, LiNi_{0.4}Co_{0.3}Mn_{0.3}O₂, or LiNi_{0.6}Co_{0.2}Mn_{0.2}O₂.

15. The lithium secondary battery cathode of claim 12, wherein an amount of the lithium gallium oxide is in a range of about 0.001 to about 15 parts by weight based on 100 parts by weight of the core active material represented by Formula 1.

16. The lithium secondary battery cathode of claim 12, wherein a thickness of the coating layer is about 800 nm or less.

17. A lithium secondary battery comprising:
a cathode;
an anode; and
a separator between the cathode and the anode,
wherein the cathode is the lithium secondary battery cathode of claim 12.
